(19) United States
(12) Patent Application Publication
(10) Pub. No.: US 2015/0249709 A1
(43) Pub. Date: Sep. 3, 2015

(54) EXTENDING CLOUD STORAGE WITH PRIVATE DEVICES

(71) Applicant: VMware, Inc., Palo Alto, CA (US)

(72) Inventors: Shengbo Teng, Beijing (CN); Chao Gary Sun, Beijing (CN); Zhibin He, Beijing (CN); Weijun Gan, Beijing (CN); Dongwei Feng, Beijing (CN)

(73) Assignee: VMware, Inc., Palo Alto, CA (US)

(21) Appl. No.: 14/194,557

(22) Filed: Feb. 28, 2014

(51) Int. Cl. H04L 29/08; G06F 17/30; H04L 12/24; H04L 29/06

(52) U.S. Cl. CPC H04L 67/1097; H04L 63/101; G06F 17/30091; H04L 41/22

(57) ABSTRACT

Techniques are described for extending public or enterprise cloud storage systems with private end user devices, such as laptops, personal computers and the like. The system allows users to register their own personal (i.e., private) devices as storage extensions to the cloud storage system. Once a user has registered their device as an extension to the cloud storage system, that device becomes available as a storage location and can be made accessible via the graphical user interface (GUI) provided by the cloud storage system. Thereafter, any user that has been granted permissions to the content is able to access the content stored on the extension device.

### BACKGROUND

With the ever growing pervasiveness of the Internet and network connectivity, cloud storage systems are becoming more and more popular amongst consumers. For example, by using a public cloud storage system, such as one offered by Box, Inc. or Dropbox, Inc., users can upload files from their personal devices to a remote server (“cloud storage”) and share those files with their friends and/or synchronize the files across multiple devices that they own. Similarly, enterprise cloud storage services, such as Office 365 or Horizon Workspace are utilized by companies to allow employees and other individuals to store applications and data on remote locations. Cloud storage services may be accessed through web services application programming interfaces (APIs), applications utilizing those APIs or by web-based content management systems.

Conventionally, if a user wants to share a file with another user (or another device), a copy of the file is stored in the cloud (i.e., on a remote server) and when one of the users modifies the file, the changes must be synchronized with the online version before any other users can access those changes. However, certain types of files can be quite large in size and for such files the speed of the synchronization with the remote server can become a significant limitation. In addition, certain users may be physically residing in locations that are geographically distant with respect to the data center in which the public cloud storage servers storing the file are housed. The geographic remoteness of such locations, as well as the varying speed of the different network connections can impact the user's experience, particularly when uploading/downloading large files to the cloud and when synchronizing changes for such large files. For example, it may take a user residing in a rural town with a slower connection an order of several magnitudes longer to upload a large file to a public cloud server when compared to a user residing in a major metropolitan area that is located geographically close to and having a high speed connection with the data center housing the servers.

### BRIEF DESCRIPTION OF THE DRAWINGS

FIG. 1 illustrates an example of a public cloud storage system being supplemented by private devices, in accordance with various embodiments;

FIG. 2 illustrates an example of a private device extension in communication with a public cloud storage server, in accordance with various embodiments;

FIG. 3 illustrates an example of an interface displayed on an access client device when accessing the public cloud storage system, in accordance with various embodiments;

FIG. 4 illustrates an example of a process for extending the public cloud storage system with private devices, in accordance with various embodiments;

FIG. 5 illustrates an example of a process for uploading content from a client device to an extension device via the public cloud storage system, in accordance with various embodiments;

FIG. 6 illustrates an example of a process for accessing content in the public cloud storage system using a client device, in accordance with various embodiments;

FIG. 7 illustrates an example of some general components of a computing device, in accordance with various embodiments.

### DETAILED DESCRIPTION

Systems and methods in accordance with various embodiments of the present disclosure provide more efficient ways to store content on servers and devices and to share that content between multiple users and devices. In particular, embodiments described herein enable a cloud storage system (e.g., public cloud storage system, enterprise cloud storage system, etc.) to be supplemented and extended by allowing users to register their own personal (i.e., private) devices as storage extensions to the cloud storage system. Once a user has registered their device as an extension to the cloud storage system, that device becomes available as a storage location and can be made accessible via the graphical user interface (GUI) provided by the cloud storage system. Thereafter, any user that has been granted permissions to the content is able to access the content stored on the extension device.

In various embodiments, when a user having an account with a public cloud storage provider wishes to register their device as an extension to the public cloud, the user can first download and install an agent onto their personal device. The agent can be an application or other software program that is responsible for registering the device with the remote public cloud storage and for allowing the user to manage the access control lists for the content stored on the registered device. As used herein, the terms “personal device” and “private device” are used interchangeably and can include any device having a processor, storage memory and capable of establishing a network connection, including but not limited to personal computers, laptops, tablet computers, cellular phones, personal digital assistants (PDAs) and the like. For at least some embodiments, if the private device is registered as an extension, it may be desirable that the device is capable of maintaining a constant connection with the remote public cloud storage servers so as not to interrupt all the various users' ability to access the content on the extension device. It should also be noted that although most of the embodiments in this disclosure are described with reference to “public” cloud storage systems, this should not be construed as a limitation to every embodiment. Some alternative embodiments can be utilized with “enterprise” cloud storage systems or other cloud storage systems available in the art.

Once the agent is installed on the device, the user is able to register the device as an extension to the public cloud storage system. As part of registering the device, the user may specify an access control list (ACL), indicating permissions (e.g., read or write permissions) for various files and folders on the device storage. In one embodiment, the agent may provide a graphical user interface (GUI) that allows the user to specify one or more other users and specify which files or folders on the extension device are accessible by those other users. For example, the user may select a particular folder on their device and indicate that particular folder as being shared with one or more friends (i.e., other users having account with the public cloud storage provider). The agent can then transmit the ACL information to the public cloud storage servers, where the ACL information will be maintained.

Once, the agent uploads the ACL to the public cloud servers, the servers can provision the user's private device as a storage extension to the public cloud. Subsequently, other users (or the same user) may use the public cloud web interface to access the private extension device and the files stored on the device if they have access rights under the ACL. The view exposed to the user can show the public cloud storage and each storage extension that the user has access to (either their own extension devices or other users' devices that have granted that user rights under their ACLs).

One of the advantages of the various embodiments described herein is that users with low speed network download/upload connections can register their own device as an extension and use the extension device for “cloud storage” instead of uploading the files to a server in a remote data center. Since the device is usually more local with respect to the geographic location of the user (e.g., on the same local area network (LAN), in the same town, etc.), the upload/download speed can be faster than uploading to a remote server. At the same time, the content can still be accessed via the public interfaces provided by the public cloud storage provider. For example, any user having the appropriate access permissions can still access the file as part of a unified public cloud interface (e.g., “dropbox.com”, etc.) even though the files and folders are stored on their own private device (or on a friend's device) instead of a remote data center. Additionally, in some embodiments, the user may wish for the content (files, folders, etc.) to not be uploaded to the public cloud storage servers (e.g., for privacy concerns, legal concerns, etc.), while still being able to access the content using the interfaces provided by the public cloud storage provider.

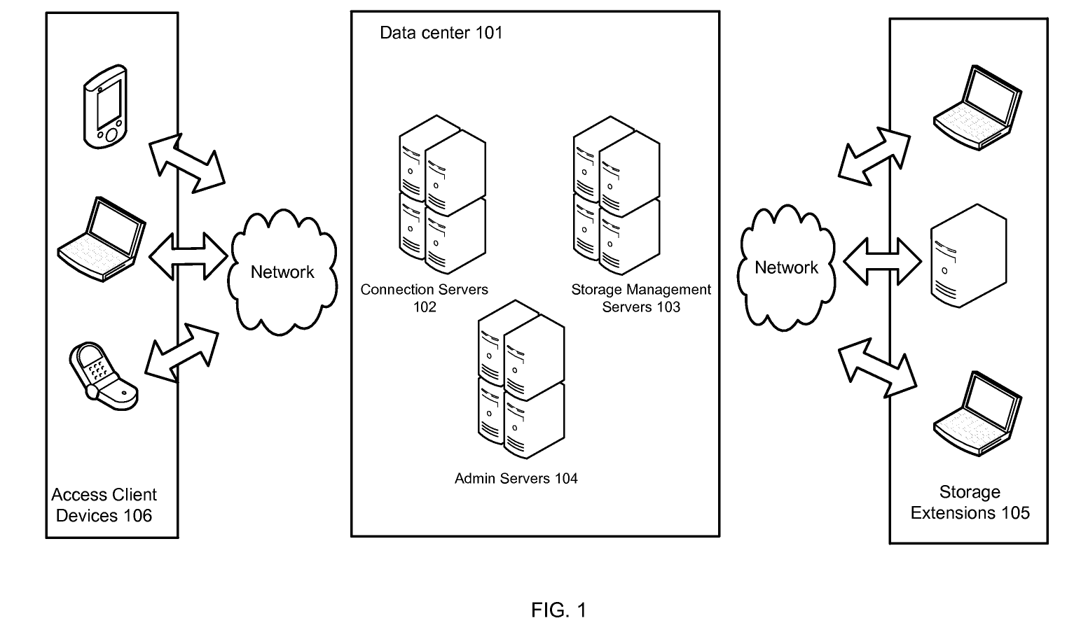

FIG. 1 illustrates an example of a public cloud storage system being supplemented by private devices, in accordance with various embodiments. As illustrated in this example, the environment of the public cloud storage system may include three main roles: (1) public cloud servers housed in a data center 101 of the public cloud storage provider, (2) access client devices 106, and (3) user storage extensions 105 having an agent installed and operating thereon. As previously mentioned, any device having a central processing unit (CPU), memory, display interface and a network connection can be used as an access client device 106, while devices with the agent installed can be used as storage extensions 105.

Public cloud storage servers can be further logically subdivided into a set of connection servers 102, storage management servers 103 and administration servers 104. In one embodiment, connection servers 102 are responsible for receiving connection requests from access client devices and generally managing connectivity of the various access client devices. The storage management servers 103, on the other hand, are responsible for receiving the register requests from user storage extensions 105 and for managing data on the devices registered as user extensions 105. In various embodiments, storage management servers 103 have a dedicated storage capacity, such that users may choose to store data in their private devices or in the public cloud storage space. For example, a user may wish to upload some files from their private device to the public cloud storage server, while maintaining other files on their private device, where all of the files are accessible via the interface of the public cloud system.

In various embodiments, the administration servers 104 are responsible for managing access rights among all of the accounts of the public cloud storage system. For example, the admin servers 104 may collect ACLs from all devices registered as storage extensions 105 and enforce those ACLs against access client devices 106.

It should be noted that although this illustration shows connection servers, admin servers and storage management servers as being separate physical devices, this is done for illustrational purposes only. It will be evident to a person of ordinary skill in the art that the functions needed to carry out the various embodiments described herein can be logically separated or combined in many different ways. For example, in some alternative embodiments, all of the functions of the public cloud storage systems can be performed by the same servers, while in other embodiments, the functions can be separated into more roles than illustrated herein.

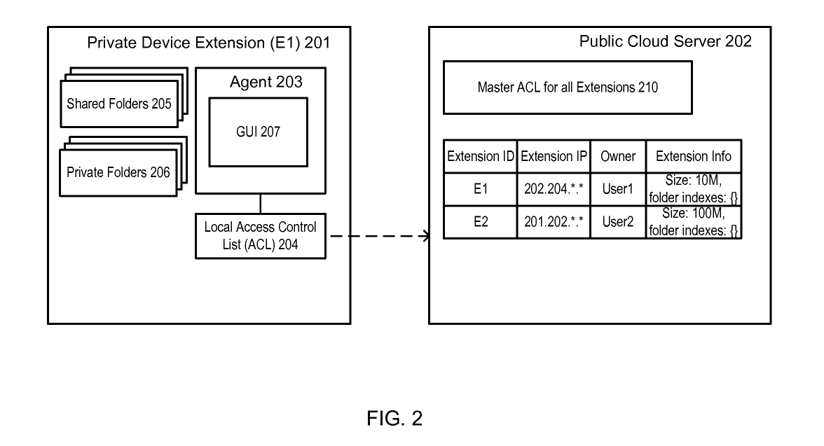

FIG. 2 illustrates an example of a private device extension in communication with a public cloud storage server, in accordance with various embodiments. As shown in this figure, the private device 201 can include an agent 203 operating thereon. The agent 203 can be a software program that is downloaded by the user (e.g., from the website of the public cloud storage provider or from some other location) and the agent 203 can facilitate the process for registering the device 201 as an extension to the public cloud storage system. In one embodiment, the agent 203 can generate a graphical user interface (GUI) 207 on the private device, which enables the user of the device to specify the access control list (ACL) 204 for the content on the device. The ACL 204 can contain permissions information for various files and folders stored on the private device 201. For example, the ACL 204 may specify that User 1 is granted permissions to read files in Folder 1 and read/write files in Folder 2, while User 2 is granted only read permissions in Folder 2. As such, the ACL 204 effectively specifies which folders on the private device 201 are shared folder 205 and which folders are private folders 206. An example of one possible format for ACL 204 is shown in the table below. In this example, the User 1 is assigned to user group “admin” and is granted read, write and execute permissions for folders 1 and 2, while User2 is assigned to user group “user” and is only granted read permissions for content stored in folder 1.

| User name | User group | Access list |
|---|---|---|
| User1 | admin | {folder1:rwx, folder2:rwx} |
| User2 | user | {folder1:r} |

Once the user specifies the ACL 204, the agent 203 sends the ACL 204 to the public cloud server 202. The public cloud server 202 can aggregate all of the ACLs into a single master ACL 210 for controlling access across all user extension devices and the public cloud storage. For example, the public cloud server 202 may be an admin server that is responsible for managing access rights across the public cloud storage system. Once access client devices access the interfaces (e.g., web interface, etc.) of the public cloud storage provider, the public cloud server 202 can determine which files/folders on which extension devices can be accessed by the client devices.

In addition, the public cloud storage server 202 maintains information about all of the private devices that have been registered as public extensions. For example, in one embodiment, each extension device is assigned an identifier (extension ID) which is associated with an Internet Protocol (IP) address, the user that is the owner of the device and a set of attributes of that device, such as size, folder indexes and the like. In some embodiments, the public cloud server 202 also maintains the ACL currently associated with the extension device. In other embodiments, all ACLs of all extension devices are merged into a single master ACL 210.

In various embodiments, once the ACL 204 of the private device 201 is uploaded to the public cloud server 202, the public cloud server 202 registers the private device 201 as an extension to the public cloud storage system. From that point forward, the private device 201 can be accessed by the users having permissions under the ACL 204. Such users can upload files to the private device, download files from the private device, and make changes to the files on the private device, all depending on the permissions associated with the corresponding user in the ACL 204.

In some embodiments, after registering the private device 201 as an extension to the public cloud storage system, the user can utilize the GUI 207 to further manage various settings and other configuration of the extension. For example, using the GUI 207, the user may specify input/output (I/O) operation limits for the extension device that are permitted to be performed by access client devices accessing the device via the public cloud storage server 202. The GUI 207 may also allow the user to specify the maximum storage space that will be permitted to be used by the access client devices which are utilizing the device via the public cloud storage server 202. For example, the user may specify that the maximum storage capacity of the shared folders 205 is set at 10 Gigabytes. In various other embodiments, the GUI 207 may allow the user to specify an administrator account, a user name and password, a backup strategy for the content accessible by client devices and the like.

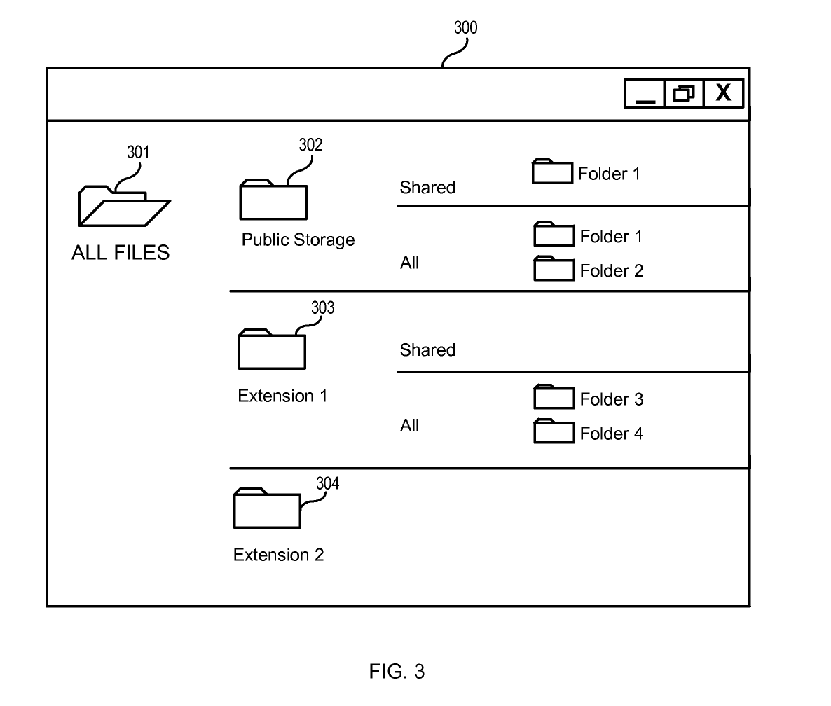

FIG. 3 illustrates an example of an interface displayed on an access client device when accessing the public cloud storage system, in accordance with various embodiments. As previously mentioned, the access client devices can be used by end users to log into the public cloud storage system, upload/download files, and to manage the files in the cloud. In various embodiments, the access client devices can be personal desktop computers, laptops and/or mobile devices, such as smart phones, tablets and the like. When a user operates a GUI displayed on the access client device, the user can see/manage all files accessible by that user in the public cloud servers, as well as on any extension storages that have granted permissions to that user.

As shown in the illustration, when a user uses an access client device to log into the public cloud storage system, the GUI 300 displayed by the access client device enables to the user to access all files 301 that are located on both public cloud storage servers 302 and private extension devices 303, 304 which have granted that user access via their respective ACLs that were uploaded by the agents operating on those extensions. In this particular example, the user has been granted shared access to folder 1 and read-only access to folder 2 on the public cloud storage server. Additionally, the user has been granted read-only access to folders 3 and 4 on extension 1 device 303. It should be noted that the GUI 300 is illustrated purely as an example and any other format or arrangement of the files, folders and other content may be equally well suited for the GUI 300, as will be evident to a person of ordinary skill in the art.

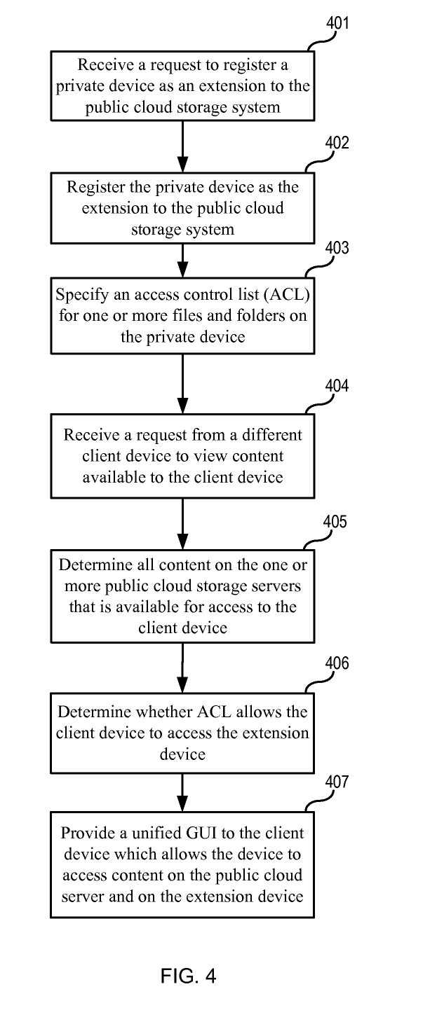

FIG. 4 illustrates an example of a process for extending the public cloud storage system with private devices, in accordance with various embodiments. This illustration shows an example of a process from the public cloud storage server perspective. As shown in operation 401, the public cloud storage server receives a request to register the private device as an extension to the public cloud storage system. In one embodiment, the request is received via a network connection from an agent operating on the private device.

In operation 402, the public cloud storage server registers the device as an extension to the public cloud storage system. In various embodiments, the agent operating on the private device uploads an access control list (ACL) that was specified by the owner of the private device. The ACL indicates which users are allowed to access which files and folders on the private extension device and the permissions for that access. Once the ACL is uploaded the public cloud server, the public cloud server can merge the ACLs of all extension devices into a single master ACL, or maintain individual copies of ACLs for each extension device.

After the device has been registered as an extension, access client devices can access the content on the extension device if they have been granted permissions to access the device. For example, in operation 404, the public cloud storage server receives a request from an access client device (i.e., a different device than the original extension) to access the content available to the client device. In response to the request, the public cloud storage server can determine all of the content on the public cloud storage system that the client device has been granted access to, as shown in operation 405. In addition, the public cloud storage server can determine all of the content on extension devices that has been granted for access to the client device. For example, as shown in operation 406, the public cloud storage server can inspect the ACL uploaded for the extension and determine whether the ACL grants permissions to the user of the client device to access the extension device.

Once the public cloud storage servers determine all of the content available to the client device, the client device can display a unified GUI that enables the user of the client device to access all of the content stored in both public cloud storage and any extensions that it has access rights to (operation 407). In some embodiments, the interface may visually separate the content located on the public cloud storage servers from the content stored on the extension devices.

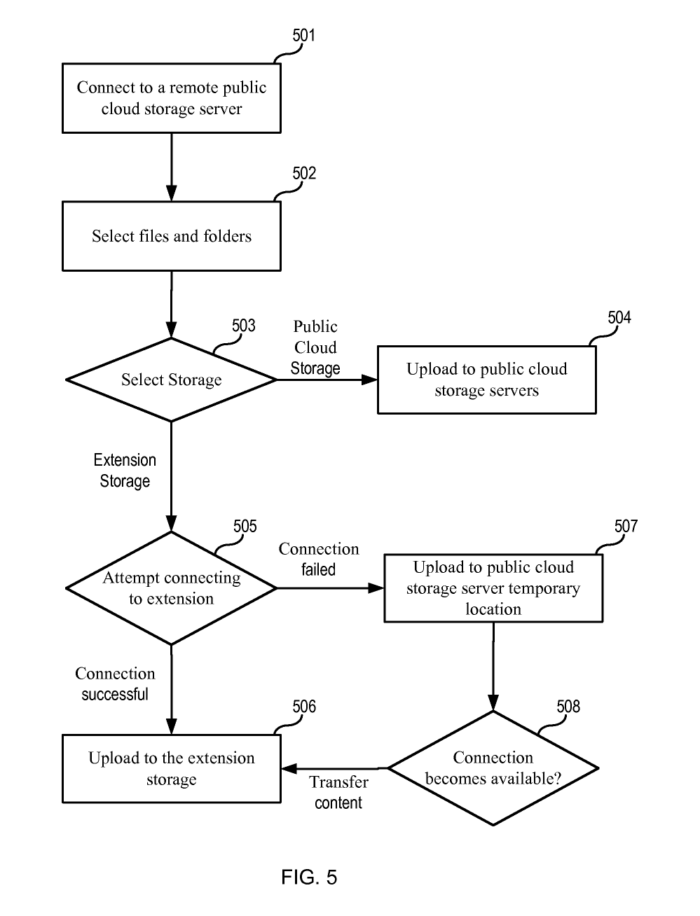

FIG. 5 illustrates an example of a process for uploading content from a client device to an extension device via the public cloud storage system, in accordance with various embodiments. In operation 501, the access client device connects to a remote public cloud storage server. The connection can be an Internet connection or any other network connection. In operation 502, the user selects files and folders on the access client device by using a GUI provided by the access client device. In operation 503, the user also selects a storage location to upload the files and/or folders to. For example, using the GUI on the client device, the user may select either public cloud storage or one of the extension devices to which that user has been granted access. If the user selects the public cloud storage location, the client device uploads the files and/or folders of content to the public cloud storage server, as shown in operation 504. If, on the other hand, the user selects one of the extension storage devices, the client device first tries to establish a connection with the extension device, as shown in operation 505. If the connection is established, the client device uploads the files and/or folders to the extension device, as shown in operation 506. If no connection can be made, the client device may instead upload the content to a temporary storage location on the public cloud storage server (operation 507). The content (i.e., files, folders, etc.) can be stored there for a period of time until the connection with the extension device can be established by the public cloud storage server (operation 508). Once the connection is established, the public cloud storage can transfer the content from the temporary location to the extension device. After all of the content has been transferred to the device, the public cloud storage may optionally remove the content from the temporary location. In some embodiments, the option of whether to remove the content or keep the content on the public cloud storage server for redundancy purposes may be made configurable by a user. It should be noted that the use of a temporary storage location on the public cloud storage system is not required as a limitation to every embodiment described herein. Some embodiments may not support such a temporary storage location. In those embodiments, any extension device that is not capable of establishing a connection would not be a candidate for storing the content.

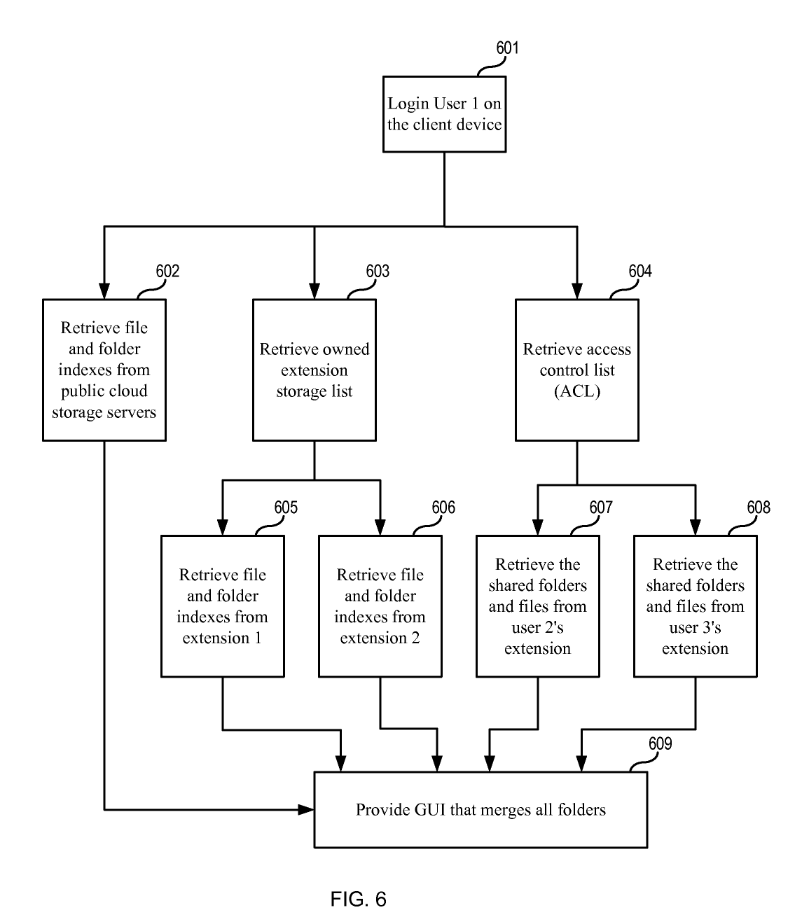

FIG. 6 illustrates an example of a process for accessing content in the public cloud storage system using a client device, in accordance with various embodiments. In operation 601, the user (e.g., User1) logs into the client device or accesses the GUI presented by the client device. The GUI may be an application running on a client device, a web application accessed over a network or a web portal accessed over an Internet connection. In operation 602, the public cloud storage server retrieves all of the file and folder indexes that are stored on the public cloud storage servers and available to be accessed by the client device. In operation 603, the public cloud storage server retrieves a list of all extension devices that are able to be accessed by the client device. Retrieving the list of extensions may also include retrieving the file and folder indexes from each extension device, as illustrated in operations 605 and 606.

In operation 604, the client device also retrieves one or more access control lists (ACLs) applicable to the user of the client device. This might include the operations of retrieving the shared folders from the extension device that is owned by a different user. For example, assuming User1 is using the client device, the public cloud storage server might retrieve the shared folders and files of User2's extension device (operation 607) and User3's extension device (operation 608). Once all of the information has been retrieved by the public cloud storage servers, the user of the client device is provided with a GUI that merges all of the folders and provides them for access to the user of the client device.

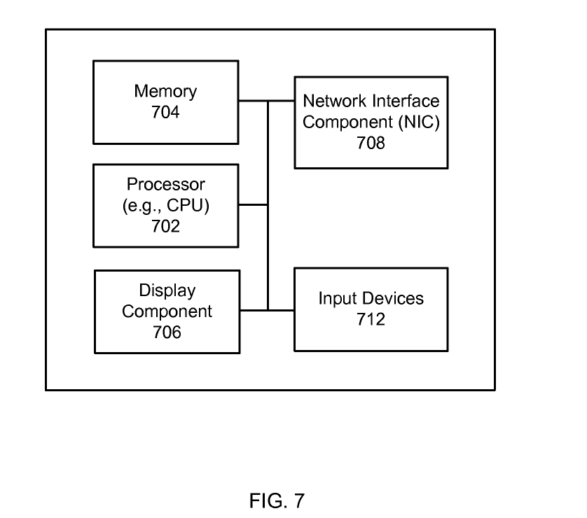

FIG. 7 illustrates an example of some general components of a computing device, in accordance with various embodiments. In this particular example, the device includes one or more processors (e.g., central processing units (CPUs) 702 for executing instructions that can be stored in physical memory component 704. The memory component 704 can include many types of memory, data storage, or non-transitory computer-readable storage media, such as random access memory (RAM) storing program instructions for execution by the processor 702, a separate form of storage for images or data, a removable memory for sharing information with other devices and the like. The memory component 704 typically can further comprise a display component 706, such as a monitor, a touch screen, liquid crystal display (LCD), or the like. In various embodiments, the computing device will include at least one input device 712 able to receive conventional input from a user. This conventional input can include, for example, a push button, touch pad, touch screen, wheel, joystick, keyboard, mouse, keypad, or any other such device or element whereby a user can input a command to the device. In some embodiments, the computing device can include a network interface component (NIC) 708 for communicating over various networks, such as a Wi-Fi, Bluetooth, RF, wired, or wireless communication systems. The device in many embodiments can communicate over a network, such as the Internet, and may be able to communicate with other devices connected to the same or other network.

Various embodiments described herein can be implemented in a wide variety of environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Many embodiments utilize at least one network that would be familiar to those skilled in the art for supporting communications using any of a variety of commercially-available protocols, such as TCP/IP, FTP, UDP or the like. The network can be, for example, a local area network, a wide-area network, a virtual private network, the Internet, an intranet, an extranet, a public switched telephone network, an infrared network, a wireless network, and any combination thereof.

The various environments in which the embodiments can be implemented may include a variety of data stores and other memory and storage media, as discussed above. These can reside in a variety of locations, such as on a storage medium local to one or more of the computers or remote from any or all of the computers across the network. In some embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for extending a public cloud storage system with private devices, said method comprising:
receiving, from an agent operating on a first private device, a request to register the first private device as an extension to the public cloud storage system, the public cloud storage system including one or more public cloud storage servers storing content;
registering the first private device as the extension to the public cloud storage system;
determining an access control list (ACL) for one or more files on the first private device based on information received from the agent on the first private device, the ACL specifying reading and writing permissions for the one or more files;
receiving, by the public cloud storage system, a request from a second private device to access content that is available to the second private device;
determining a subset of the content stored on the one or more public cloud storage servers that is available for access to the second private device;
determining, by the public cloud storage system, whether the ACL grants the second private device access to the one or more files stored on the first private device registered as the extension to the public cloud storage system; and
in response to determining that the ACL grants the second private device access to the one or more files:
providing a graphical user interface (GUI) that enables the second private device to access both (a) the subset of the content stored on the one or more public cloud storage servers and (b) the one or more files stored on the first private device.

2. The method of claim 1, wherein the first private device corresponds to a first user and the second private device corresponds to a second user and wherein the first user grants the second user access to the one or more files by indicating the second user in the ACL.

3. The method of claim 1, wherein the agent is a software program that is downloaded and installed on the first private device to enable the first private device to be registered as the extension to the public cloud storage system.

4. The method of claim 1, further comprising:
in response to receiving the request from the second private device,
determining, based on the ACL, a plurality of private devices that store content available to be accessed by the second private device; and
displaying, in the GUI, the content stored on the plurality of private devices that is available to be accessed by the second private device.

5. The method of claim 1, wherein the first private device is configured to maintain a stable network connection with the one or more public cloud storage servers after being registered as the extension to the public cloud storage system.

6. The method of claim 1, further comprising:
receiving, by the one or more public cloud storage servers, a request from the first private device to view content that is available for access to the first private device;
determining a subset of the content stored on the one or more public cloud storage servers that is available for access to the first private device; and
providing a graphical user interface (GUI) to the first private device, the GUI configured to enable the first private device to access the subset of the content stored on the one or more public cloud storage servers that is available for access to the first private device.

7. The method of claim 1, wherein the agent on the first private device provides an interface to enable the first private device to set one or more extension storage settings, the extension storage settings including one or more of:
a maximum Input/Output (I/O) speed limit for other private devices accessing content on the first private device;
maximum storage space that is accessible by other private devices on the first private device;
an administrative account and password; and
a backup strategy for content on the first private device.

8. A computing device, comprising:
at least one processor; and
memory including instructions that, when executed by the at least one processor, cause the computing device to:
receive, from an agent operating on a first private device, a request to register the first private device as an extension to a cloud storage system, the cloud storage system including one or more cloud storage servers storing content;
register the first private device as the extension to the cloud storage system;
determine an access control list (ACL) for one or more files on the first private device based on information received from the agent on the first private device, the ACL specifying reading and writing permissions for the one or more files;
receive, by the cloud storage system, a request from a second private device to access content that is available to the second private device;
determine a subset of the content stored on the one or more cloud storage servers that is available for access to the second private device;
determine, by the cloud storage system, whether the ACL grants the second private device access to the one or more files stored on the first private device registered as the extension to the cloud storage system; and
in response to determining that the ACL grants the second private device access to the one or more files:
provide a graphical user interface (GUI) that enables the second private device to access both (a) the subset of the content stored on the one or more cloud storage servers and (b) the one or more files stored on the first private device.

9. The computing device of claim 8, wherein the first private device corresponds to a first user and the second private device corresponds to a second user and wherein the first user grants the second user access to the one or more files by indicating the second user in the ACL.

10. The computing device of claim 8, wherein the agent is a software program that is downloaded and installed on the first private device to enable the first private device to be registered as the extension to the cloud storage system.

11. The computing device of claim 8, the memory further comprising instructions, that when executed by the at least one processor, cause the computing device to:
in response to receiving the request from the second private device,
determine, based on the ACL, a plurality of private devices that store content available to be accessed by the second private device; and
display, in the GUI, the content stored on the plurality of private devices that is available to be accessed by the second private device.

12. The computing device of claim 8, wherein the first private device is configured to maintain a stable network connection with the one or more cloud storage servers after being registered as the extension to the cloud storage system.

13. The computing device of claim 8, the memory further comprising instructions, that when executed by the at least one processor, cause the computing device to:
receive, by the one or more cloud storage servers, a request from the first private device to view content that is available for access to the first private device;
determine a subset of the content stored on the one or more cloud storage servers that is available for access to the first private device; and
provide a graphical user interface (GUI) to the first private device, the GUI configured to enable the first private device to access the subset of the content stored on the one or more cloud storage servers that is available for access to the first private device.

14. The computing device of claim 8, wherein the agent on the first private device provides an interface to enable the first private device to set one or more extension storage settings, the extension storage settings including one or more of:
a maximum Input/Output (I/O) speed limit for other private devices accessing content on the first private device;
maximum storage space that is accessible by other private devices on the first private device;
an administrative account and password; and
a backup strategy for content on the first private device.

15. A non-transitory computer readable storage medium comprising one or more sequences of instructions, the instructions when executed by one or more processors causing the one or more processors to execute the operations of:
receiving, from an agent operating on a first private device, a request to register the first private device as an extension to the cloud storage system, the cloud storage system including one or more cloud storage servers storing content;
registering the first private device as the extension to the cloud storage system;
determining an access control list (ACL) for one or more files on the first private device based on information received from the agent on the first private device, the ACL specifying reading and writing permissions for the one or more files;
receiving, by the cloud storage system, a request from a second private device to access content that is available to the second private device;
determining a subset of the content stored on the one or more cloud storage servers that is available for access to the second private device;
determining, by the cloud storage system, whether the ACL grants the second private device access to the one or more files stored on the first private device registered as the extension to the cloud storage system; and
in response to determining that the ACL grants the second private device access to the one or more files:
providing a graphical user interface (GUI) that enables the second private device to access both (a) the subset of the content stored on the one or more cloud storage servers and (b) the one or more files stored on the first private device.

16. The non-transitory computer readable storage medium of claim 15, wherein the first private device corresponds to a first user and the second private device corresponds to a second user and wherein the first user grants the second user access to the one or more files by indicating the second user in the ACL.

17. The non-transitory computer readable storage medium of claim 15, wherein the agent is a software program that is downloaded and installed on the first private device to enable the first private device to be registered as the extension to the cloud storage system.

18. The non-transitory computer readable storage medium of claim 15, further comprising instructions that when executed by the one or more processors, cause the one or more processors to perform the operations of:
in response to receiving the request from the second private device,
determining, based on the ACL, a plurality of private devices that store content available to be accessed by the second private device; and
displaying, in the GUI, the content stored on the plurality of private devices that is available to be accessed by the second private device.

19. The non-transitory computer readable storage medium of claim 15, wherein the first private device is configured to maintain a stable network connection with the one or more cloud storage servers after being registered as the extension to the cloud storage system.

20. The non-transitory computer readable storage medium of claim 15, further comprising instructions that when executed by the one or more processors, cause the one or more processors to perform the operations of:
receiving, by the one or more cloud storage servers, a request from the first private device to view content that is available for access to the first private device;
determining a subset of the content stored on the one or more cloud storage servers that is available for access to the first private device; and
providing a graphical user interface (GUI) to the first private device, the GUI configured to enable the first private device to access the subset of the content stored on the one or more cloud storage servers that is available for access to the first private device.
